(19) United States
(12) Patent Application Publication
(10) Pub. No.: US 2026/0298410 A1
(43) Pub. Date: Oct. 1, 2026

(54) SULFUR DIOXIDE MIXTURE-FILLED CONTAINER AND SULFUR DIOXIDE COMPOSITION

(71) Applicant: SUMITOMO SEIKA CHEMICALS CO., LTD., Kako-gun, Hyogo (JP)

(72) Inventors: Hiroki YAMAUCHI, Kako-gun, Hyogo (JP); Rena ASAKAWA, Kako-gun, Hyogo (JP)

(21) Appl. No.: 18/881,588

(22) PCT Filed: Aug. 14, 2023
(86) PCT No.: PCT/JP2023/029450

§ 371 Date: Jan. 6, 2025

(30) Foreign Application Priority Data
Sep. 6, 2022 (JP) 2022-141324

(51) Int. Cl. F17C 3/12; C01B 17/56

(52) U.S. Cl. CPC F17C 3/12; C01B 17/56; C01P 2006/82; F17C 2201/0119; F17C 2201/032; F17C 2203/0639; F17C 2203/068; F17C 2223/0123

(57) ABSTRACT

A sulfur dioxide mixture-filled container includes a sealed container, and a sulfur dioxide mixture that is filled in the sealed container and contains at least sulfur dioxide and water in a vapor phase. In the sulfur dioxide mixture-filled container, the sealed container includes a cylindrical body portion including a metal layer having an inner surface in contact with a sulfur dioxide mixture, and a maximum height of a surface roughness of the inner surface of the metal layer of the cylindrical body portion is 38 μm or less.

### TECHNICAL FIELD

The present invention relates to a sulfur dioxide mixture-filled container and a sulfur dioxide composition.

### BACKGROUND ART

A container used for storing and transporting a liquefied gas and a compressed gas is generally made of a metal such as steel or an alloy, and is used for storing and supplying a gas in various industries. In recent years, demand for sulfur dioxide among other liquefied gases has been increasing in a semiconductor manufacturing process. However, the sulfur dioxide has corrosiveness to metals and corrodes a sealed container, so that this property may cause a trace amount of metal impurities in the gas, which is a concern in the semiconductor manufacturing process. As a solution to this problem, there is an example in which corrosion resistance of a sealed container or a pipe is imparted by limiting an impurity concentration of sulfur dioxide to be filled. For example, Patent Literature 1 proposes that metal corrosion is suppressed by a sulfur dioxide mixture in which a concentration of water in a vapor phase is 0.005 mol ppm or more and less than 5000 mol ppm.

### CITATION LIST

### Patent Literature

[Patent Literature 1] WO2021-182045A

### SUMMARY OF INVENTION

### Technical Problem

However, the sulfur dioxide mixture described in Patent Literature 1 had the following problems.

That is, the sulfur dioxide mixture described in Patent Literature 1 is intended for use in a sealed container made of stainless steel generally known to have corrosion resistance to sulfur dioxide, and is not designed for use without restrictions on the metal material of the sealed container. In other words, in a case where the above-mentioned sulfur dioxide mixture is used, in a case where the sealed container is made of a metal material other than stainless steel, there was a risk that the sealed container may be corroded.

The present invention has been made in view of the above-mentioned problems, and an object of the present invention is to provide a sulfur dioxide mixture-filled container and a sulfur dioxide composition capable of suppressing corrosion of a sealed container by a sulfur dioxide mixture even in a case where a metal material of the sealed container is other than stainless steel.

### Solution to Problem

As a result of intensive studies to solve the above-mentioned problems, the present inventors have found that the above-mentioned problems can be solved by specifying a maximum height of a surface roughness of an inner surface of a cylindrical body portion of a sealed container storing a sulfur dioxide mixture in a specific range.

That is, one aspect of the present invention provides a sulfur dioxide mixture-filled container including a sealed container made of a metal, and a sulfur dioxide mixture that is filled in the above-mentioned sealed container and contains at least sulfur dioxide and water in a vapor phase, in which the above-mentioned sealed container includes a cylindrical body portion and a maximum height of a surface roughness of an inner surface of the above-mentioned cylindrical body portion is 38 μm or less.

The cylindrical body portion in the present invention follows the definition described in JIS B 0190:2010.

According to the above-mentioned sulfur dioxide mixture-filled container, even in a case where a metal material of the sealed container is other than stainless steel, corrosion of the sealed container due to the sulfur dioxide mixture can be suppressed.

The reason why the corrosion of the sealed container due to the sulfur dioxide mixture can be suppressed even in a case where the metal material of the sealed container is other than stainless steel by the present invention is not clear, but the present inventors presume that it is based on the following reason.

That is, by setting the maximum height of the surface roughness of the inner surface of the cylindrical body portion of the sealed container to 38 μm or less, the water in the sulfur dioxide mixture is less likely to be captured in a recess of the inner surface of the cylindrical body portion, and even in a case where the water is captured, the water is easily released. Therefore, the amount of the sulfur dioxide which is dissolved in the water is reduced, and generation of a corrosive substance due to a reaction between the water and the sulfur dioxide gas is suppressed. In this way, the present inventors presume that the corrosion of the sealed container is suppressed even in a case where the metal material of the sealed container is other than stainless steel.

Another aspect of the present invention provides a sulfur dioxide composition obtained by being extracted from the above-mentioned sulfur dioxide mixture-filled container.

According to the sulfur dioxide mixture filled in the above-mentioned sealed container, it is possible to suppress corrosion of a sealed container made of a metal including a cylindrical body portion and having a maximum height of a surface roughness of an inner surface of a cylindrical body portion of 38 μm or less. Therefore, the corrosion of the sealed container can be suppressed even in a case where the metal material of the sealed container is other than stainless steel. Therefore, by suppressing the corrosion of the sealed container, it is possible to suppress the mixing of a metal component in the sulfur dioxide mixture. Therefore, the sulfur dioxide composition obtained by being extracted from the sulfur dioxide mixture-filled container is useful in a semiconductor manufacturing process or the like in which a low content of the metal component is required.

In the above-mentioned sulfur dioxide mixture-filled container, it is preferable that a concentration of the above-mentioned water in the above-mentioned sulfur dioxide mixture is 1000 mol ppm or less.

In the above-mentioned sulfur dioxide mixture-filled container, it is preferable that the maximum height of the surface roughness of the above-mentioned inner surface of the above-mentioned cylindrical body portion is 23 μm or less.

In the above-mentioned sulfur dioxide mixture-filled container, it is more preferable that the maximum height of the surface roughness of the above-mentioned inner surface of the above-mentioned cylindrical body portion is 6 μm or less.

In the above-mentioned sulfur dioxide mixture-filled container, it is still more preferable that the maximum height of the surface roughness of the above-mentioned inner surface of the above-mentioned cylindrical body portion is 1 μm or less.

In the above-mentioned sulfur dioxide mixture-filled container, the metal constituting the above-mentioned sealed container may include an alloy steel.

The above-mentioned alloy steel may be manganese steel or chromium molybdenum steel.

### Advantageous Effects of Invention

According to the present invention, there are provided a sulfur dioxide mixture-filled container capable of suppressing corrosion of a sealed container by a sulfur dioxide mixture even in a case where a metal material of the sealed container is other than stainless steel, and a sulfur dioxide composition.

### BRIEF DESCRIPTION OF DRAWINGS

FIG. 1 is a partially cross-sectional view schematically showing one embodiment of a sulfur dioxide mixture-filled container according to the present invention.

FIG. 2 is a flowchart showing an example of a corrosion resistance test device used in Experimental Example.

FIG. 3 is a graph showing a relationship between a maximum height Rz of a surface roughness and an average S (sulfur) concentration at a depth of 100 to 200 nm (in terms of a SiO₂ thermal oxide film) from a surface of a test piece in Experimental Examples 1 to 16.

### DESCRIPTION OF EMBODIMENTS

Hereinafter, embodiments of a sulfur dioxide mixture-filled container according to the present invention will be described in detail with reference to the drawings. In the drawings, the same or corresponding parts are denoted by the same reference numerals, and redundant description will be omitted. Furthermore, dimensional ratios in the drawings are not limited to the shown ratios.

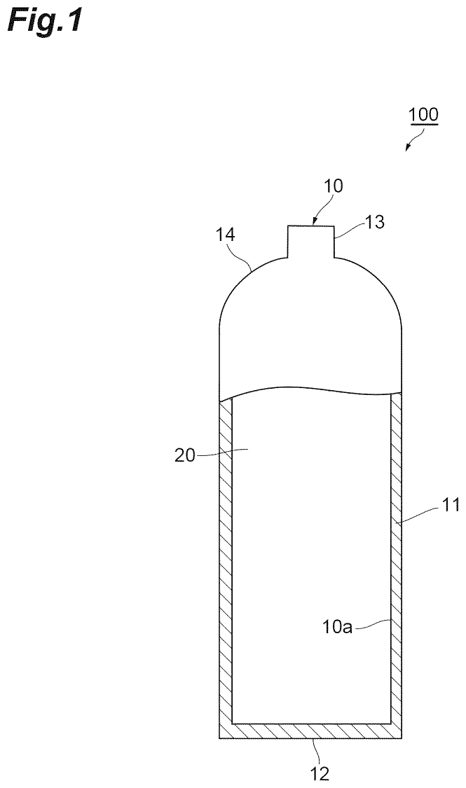

FIG. 1 is a partially cross-sectional view schematically showing one embodiment of a sulfur dioxide mixture-filled container according to the present invention. As shown in FIG. 1, a sulfur dioxide mixture-filled container 100 includes a sealed container 10 made of metal, and a sulfur dioxide mixture 20 that is filled in the sealed container 10 and contains sulfur dioxide and water in a vapor phase.

The sealed container 10 includes the cylindrical body portion 11. In addition, a maximum height Rz of a surface roughness of an inner surface 10a of the cylindrical body portion 11 is 38 μm or less.

According to the above-mentioned sulfur dioxide mixture-filled container 100, even in a case where a metal material of the sealed container 10 is other than stainless steel, corrosion of the sealed container 10 due to the sulfur dioxide mixture can be suppressed.

Hereinafter, the sealed container 10 and the sulfur dioxide mixture 20 will be described in more detail.

### <Sealed Container>

The sealed container 10 includes the cylindrical body portion 11. Specifically, as shown in FIG. 1, the sealed container 10 further includes a bottom 12 provided at a lower end of the cylindrical body portion 11, a gas discharge portion 13 provided on an upper end side of the cylindrical body portion 11 and provided with a valve for filling or discharging the sulfur dioxide mixture 20, and a shoulder portion 14 that connects the gas discharge portion 13 and the cylindrical body portion 11 to each other.

The sealed container 10 only needs to be made of a metal, and may be composed of a single metal layer or a laminate of two or more metal layers.

The maximum height Rz of the surface roughness of the inner surface 10a of the cylindrical body portion 11 only needs to be 38 μm or less. From a viewpoint of further suppressing the corrosion of the sealed container 10 by the sulfur dioxide mixture 20, the maximum height Rz of the surface roughness of the inner surface 10a of the cylindrical body portion 11 is preferably 23 μm or less, more preferably 6 μm or less, and still more preferably 1 μm or less.

The maximum height Rz of the surface roughness of the inner surface of a portion other than the cylindrical body portion 11 (for example, the bottom 12, the gas discharge portion 13, and the shoulder portion 14) is not particularly limited, and may be 38 μm or less or may be more than 38 μm.

The maximum height Rz of the surface roughness of the inner surface 10a of the cylindrical body portion 11 can be realized, for example, by polishing the inner surface of an unpolished container. Examples of a polishing method include a physical polishing method such as blast polishing, buff polishing, and centrifugal barrel polishing, a chemical polishing method of performing a treatment with chemicals, and an electropolishing method of turning on electricity and polishing by bringing into contact with an electropolishing solution. The polishing method is not particularly limited to the above-mentioned polishing method.

The maximum height Rz of the surface roughness of the inner surface 10a of the cylindrical body portion 11 in the present invention can be measured based on JIS B 0633:2001 and JIS B 0651:2001.

Specifically, in a case of measuring the maximum height Rz of the surface roughness, a surface roughness measuring device commercially available by a meter manufacturer can be used. Examples of such a surface roughness measuring device include a surface roughness measuring device manufactured by Mitutoyo Corporation.

The metal constituting the sealed container 10 is not particularly limited, and examples thereof include alloy steel such as manganese steel, stainless steel, and chromium molybdenum steel, carbon steel, and an aluminum alloy.

Among these, alloy steel is preferable. In this case, the sulfur dioxide mixture-filled container 100 is advantageous in terms of mechanical properties as compared with a case of using a metal other than the alloy steel in the sealed container 10. Among the alloy steels, manganese steel or chromium molybdenum steel is preferable. In this case, the sulfur dioxide mixture-filled container 100 is advantageous in terms of cost as compared with a case in which alloy steel other than manganese steel or chromium molybdenum steel is used in the sealed container 10.

### <Sulfur Dioxide Mixture>

The sulfur dioxide mixture 20 contains sulfur dioxide and water in a vapor phase.

The concentration of the water in a vapor phase in the sulfur dioxide mixture 20 is not particularly limited, and is preferably 1000 mol ppm or less. Here, the concentration of the water in a vapor phase in the sulfur dioxide mixture 20 is a value measured by a phosphorus pentoxide type dew point hygrometer or a cavity ring-down spectroscopy (CRDS). Here, the measurement is performed under conditions of 20° C. to 25° C. (40° C. in a case of a pipe through which the sulfur dioxide mixture flows) and atmospheric pressure.

The concentration of the water in a vapor phase in the sulfur dioxide mixture 20 is, for example, 400 mol ppm or less, 100 mol ppm or less, 10 mol ppm or less, or 1 mol ppm or less.

Here, in particular, in a case where the maximum height Rz of the surface roughness is 23 μm or less, the corrosion of the sealed container 10 by the sulfur dioxide mixture can be effectively suppressed.

The concentration of the water in a vapor phase in the sulfur dioxide mixture 20 may be higher than 400 mol ppm.

In this case, since the range of the concentration of the water becomes wider, a process margin in equipment (water removing equipment) for purifying the sulfur dioxide mixture becomes wider. Therefore, the concentration of the water in a vapor phase in the sulfur dioxide mixture 20 higher than 400 mol ppm is advantageous from the viewpoint of process control in the manufacturing equipment for the sulfur dioxide mixture. In addition, in a case where the concentration of the water in a vapor phase in the sulfur dioxide mixture 20 is higher than 400 mol ppm, it is possible to eliminate the need for the equipment (the water removing equipment) itself for purifying the sulfur dioxide mixture.

The sulfur dioxide may be a liquefied gas or a non-liquefied gas, but is usually a liquefied gas.

A method of filling the sulfur dioxide mixture 20 is not particularly limited, but in a case where water remains in the sealed container 10, the concentration of the water in the filled sulfur dioxide mixture 20 is increased. Therefore, the inside of the sealed container 10 may be ventilated with dried inert gas in advance or the sealed container 10 may be subjected to a heat and vacuum treatment or the like so that a residual water amount in the sealed container 10 is 1 mol ppm or less.

### <Sulfur Dioxide Composition>

A sulfur dioxide composition of the present invention is a composition obtained by being extracted from the sulfur dioxide mixture-filled container 100.

According to the sulfur dioxide mixture filled in the above-mentioned sealed container 10, it is possible to suppress corrosion of a sealed container 10 made of a metal including a cylindrical body portion 11 and having a maximum height of a surface roughness of an inner surface 10a of a cylindrical body portion 11 of 38 μm or less. Therefore, the corrosion of the sealed container 10 can be suppressed even in a case where the metal material of the sealed container 10 is other than stainless steel. Therefore, by suppressing the corrosion of the sealed container 10, it is possible to suppress the mixing of a metal component in the sulfur dioxide mixture. Therefore, the sulfur dioxide composition obtained by being extracted from the sulfur dioxide mixture-filled container 100 is useful in a semiconductor manufacturing process or the like in which a low content of the metal component is required.

### EXPERIMENTAL EXAMPLES

Hereinafter, experimental examples will be described.

### [Test Piece]

Each of a rectangular (10 mm×50 mm×6 mm) manganese steel (150M36-S) having the maximum height Rz of a surface roughness of 1 μm, a rectangular (10 mm×50 mm×6 mm) manganese steel (150M36-S) having the maximum height Rz of a surface roughness of 20 μm, a rectangular (10 mm×50 mm×6 mm) manganese steel (150M36-S) having the maximum height Rz of a surface roughness of 35 μm, a rectangular (10 mm×50 mm×6 mm) manganese steel (150M36-S) having the maximum height Rz of a surface roughness of 40 μm, a rectangular (10 mm×50 mm×6 mm) manganese steel (150M36-S) having the maximum height Rz of a surface roughness of 145 μm, a rectangular (20 mm×50 mm×6 mm) chromium molybdenum steel (SAE4130-S) having the maximum height Rz of a surface roughness of 2 μm, a rectangular (20 mm×50 mm×6 mm) chromium molybdenum steel (SAE4130-S) having the maximum height Rz of a surface roughness of 45 μm, and a rectangular (20 mm×50 mm×6 mm) chromium molybdenum steel (SAE4130-S) having the maximum height Rz of a surface roughness of 125 μm was prepared as a test piece. The maximum height Rz of the surface roughness of the test piece was measured using a contact type surface roughness measuring device based on JIS B 0633:2001 and JIS B 0651:2001. As the contact type surface roughness measuring device, “SJ-210” manufactured by Mitutoyo Corporation was used for the test pieces having the maximum heights Rz of 1 μm, 2 μm, 20 μm, 35 μm, 40 μm, and 45 μm. As the contact type surface roughness measuring device, “SJ-412” manufactured by Mitutoyo Corporation was used for the test pieces having the maximum heights Rz of 125 μm and 145 μm. The test piece is used instead of the sealed container in order to examine the effect of a value of the maximum height of the surface roughness of the inner surface of the cylindrical body portion of the sealed container.

### Experimental Example 1

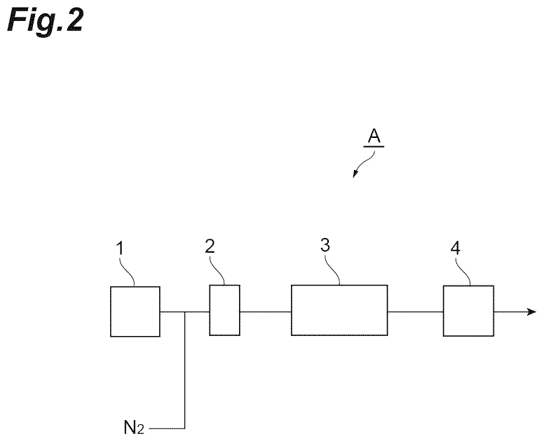

The manganese steel test piece having the maximum height Rz of the surface roughness of 1 μm was hung on a hook with a surface covered with Teflon (registered trademark) and placed in a storage container 3 made of SUS304 in a corrosion resistance test device A shown in FIG. 2, and the storage container 3 was sealed. Next, the storage container 3 was ventilated with a nitrogen gas at 2 L/min for 12 hours or longer to remove the water inside the storage container 3.

Subsequently, the storage container 3 was ventilated with a sulfur dioxide mixed gas raw material 1 having a concentration of water in a vapor phase of 1 mol ppm and containing sulfur dioxide as a sulfur dioxide mixed gas at 2 L/min for 30 minutes or longer. At this time, a flow rate of the sulfur dioxide mixed gas was adjusted by the flow rate adjuster 2. In addition, for the sulfur dioxide mixed gas discharged from the storage container 3, the concentration of the water in a vapor phase was measured with a water meter 4, and it was confirmed that the concentration of the water in a vapor phase was 1 mol ppm.

Subsequently, the storage container 3 was sealed such that an internal pressure was 0.02 MPaG, and the storage container 3 was filled with the sulfur dioxide mixed gas.

The above-mentioned sulfur dioxide mixed gas was stored at room temperature (25° C.) for about 30 days, and then the inside of the storage container 3 was sufficiently replaced with a nitrogen gas. Thereafter, the storage container 3 was opened to extract the test piece, sputtering was performed on a surface of the test piece, and the S (sulfur) concentration along a depth direction from the surface of the test piece was measured by XPS (X-ray photoelectron spectroscopy) analysis. Target elements were C, O, S, Mn, and Fe. A depth converted in terms of a SiO₂ thermal oxide film specifically shows a distance along the depth direction in a case where the SiO₂ thermal oxide film is measured under the same conditions.

In addition, based on the measurement result of the S (sulfur) concentration, an average S (sulfur) concentration at a depth of 100 to 200 nm (in terms of a SiO₂ thermal oxide film) from the surface of the test piece was calculated. The results are shown in Table 1. Here, the average S (sulfur) concentration is an index of the amount of corrosive substances generated by a reaction between water and a sulfur dioxide gas, and indicates that the amount of corrosive substances generated is smaller as the average S concentration is lower, that is, the corrosion of the test piece is suppressed.

Furthermore, for the average S (sulfur) concentration calculated as described above, the degree of suppression of the corrosion of the test piece by a sulfur dioxide mixture was evaluated based on the following evaluation criteria. The results are shown in Table 1.

### Evaluation Criteria

O: Average S (sulfur) concentration at a depth of 100 to 200 nm (in terms of a SiO₂ thermal oxide film) from the surface of the test piece was 0.4 atomic % or less.

X: Average S (sulfur) concentration at a depth of 100 to 200 nm (in terms of a SiO₂ thermal oxide film) from the surface of the test piece was more than 0.4 atomic %.

### Experimental Examples 2 to 16

The storage container 3 was filled with the sulfur dioxide mixed gas in the same manner as in Experimental Example 1, except that a manganese steel test piece or a chromium molybdenum steel test piece in which the maximum height Rz of the surface roughness is a value shown in Table 1 was used as the test piece, and the sulfur dioxide mixed gas raw material 1 in which the concentration of the water in a vapor phase is a value shown in Table 1 and contains sulfur dioxide was used as the sulfur dioxide mixed gas raw material 1.

Then, a sulfur dioxide mixed gas was stored in the same manner as in Experimental Example 1, and the inside of the storage container 3 was sufficiently replaced with a nitrogen gas. Thereafter, the storage container 3 was opened to extract the test piece, and the S (sulfur) concentration along the depth direction from the surface of the test piece was measured by XPS analysis in the same manner as in Experimental Example 1. In addition, in the same manner as in Experimental Example 1, based on the measurement result of the S (sulfur) concentration, an average S (sulfur) concentration at a depth of 100 to 200 nm (in terms of a SiO₂ thermal oxide film) from the surface of the test piece was calculated. The results are shown in Table 1.

Furthermore, for the average S (sulfur) concentration calculated as described above, the degree of suppression of the corrosion of the test piece by a sulfur dioxide mixture was evaluated based on the evaluation criteria. The results are shown in Table 1.

TABLE 1

| | | | | Average S | |
|---|---|---|---|---|---|
| | | | | concentration | |
| | | | | at depth | |
| | | | | of 100 to | |
| | | Maximum | | 200 nm (in | |
| | | height Rz | Concentration | terms of | |
| | | of surface | of water in | SiO₂ thermal | |
| | Test piece | roughness | vapor phase | oxide film) | |
| | material | [μm] | [mol ppm] | [atomic %] | Evaluation |
| Experimental | Mn steel | 1 | 1 | 0.05 | O |
| Example 1 | | | | | |
| Experimental | Mn steel | 20 | 1 | 0.09 | O |
| Example 2 | | | | | |
| Experimental | Mn steel | 35 | 1 | 0.33 | O |
| Example 3 | | | | | |
| Experimental | Mn steel | 40 | 1 | 0.95 | X |
| Example 4 | | | | | |
| Experimental | Mn steel | 145 | 1 | 0.78 | X |
| Example 5 | | | | | |
| Experimental | Mn steel | 1 | 480 | 0.03 | O |
| Example 6 | | | | | |
| Experimental | Mn steel | 20 | 480 | 0.09 | O |
| Example 7 | | | | | |
| Experimental | Mn steel | 35 | 480 | 0.21 | O |
| Example 8 | | | | | |
| Experimental | Mn steel | 40 | 480 | 1.11 | X |
| Example 9 | | | | | |
| Experimental | Mn steel | 145 | 480 | 0.90 | X |
| Example 10 | | | | | |
| Experimental | Cr-Mo steel | 2 | 1 | 0.06 | O |
| Example 11 | | | | | |
| Experimental | Cr-Mo steel | 45 | 1 | 0.72 | X |
| Example 12 | | | | | |
| Experimental | Cr-Mo steel | 125 | 3 | 0.87 | X |
| Example 13 | | | | | |
| Experimental | Cr-Mo steel | 2 | 480 | 0.10 | O |
| Example 14 | | | | | |
| Experimental | Cr-Mo steel | 45 | 480 | 1.07 | X |
| Example 15 | | | | | |
| Experimental | Cr-Mo steel | 125 | 480 | 1.11 | X |
| Example 16 | | | | | |

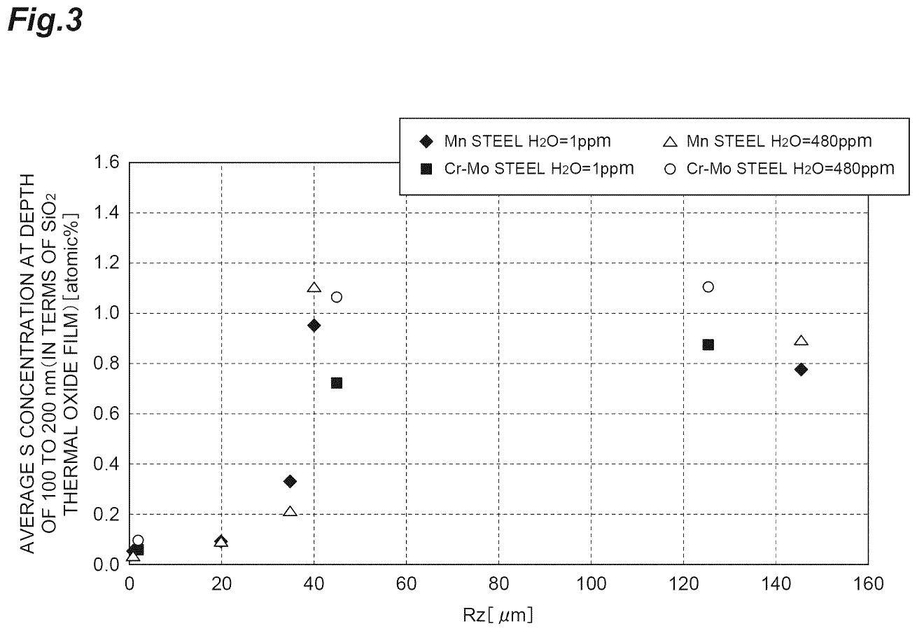

Based on the results shown in Table 1, FIG. 3 shows the results of plotting the average S (sulfur) concentration in the test piece at a depth of 100 to 200 nm (in terms of a SiO₂ thermal oxide film) from the surface by the XPS analysis with respect to the maximum height Rz of the surface roughness of the test piece. In FIG. 3, a horizontal axis represents the maximum height Rz of the surface roughness of the test piece, and a vertical axis represents the average S (sulfur) concentration in the test piece at a depth of 100 to 200 nm (in terms of a SiO₂ thermal oxide film) from the surface. In addition, in FIG. 3, “H₂O” refers to the concentration of the water in a vapor phase, and “ppm” refers to “mol ppm”.

The test results of the test piece shown in Table 1 and FIG. 3 can also be similarly applied to a sealed container made of non-stainless steel, other than manganese steel and chromium molybdenum steel. That is, even in a case where the metal material of the sealed container is other than stainless steel, it is considered that, in a case where the maximum height Rz of the surface roughness of the inner surface of the cylindrical body portion is 38 μm or less, the corrosion of the sealed container by the sulfur dioxide mixed gas regardless of the concentration of the water in a vapor phase is suppressed.

The summary of the present invention is as follows.

[1] A sulfur dioxide mixture-filled container including a sealed container made of a metal, and a sulfur dioxide mixture that is filled in the sealed container and contains at least sulfur dioxide and water in a vapor phase, in which the sealed container includes a cylindrical body portion, and a maximum height of a surface roughness of an inner surface of the cylindrical body portion is 38 μm or less.

[2] The sulfur dioxide mixture-filled container according to [1], in which the maximum height of the surface roughness of the inner surface of the cylindrical body portion is 23 μm or less.

[3] The sulfur dioxide mixture-filled container according to [2], in which the maximum height of the surface roughness of the inner surface of the cylindrical body portion is 6 μm or less.

[4] The sulfur dioxide mixture-filled container according to any one of [1] to [3], in which a concentration of the water in the sulfur dioxide mixture is 1000 mol ppm or less.

[5] The sulfur dioxide mixture-filled container according to any one of [1] to [4], in which the metal constituting the sealed container includes an alloy steel.

[6] The sulfur dioxide mixture-filled container according to [5], in which the alloy steel is manganese steel or chromium molybdenum steel.

[7] A sulfur dioxide composition obtained by being extracted from the sulfur dioxide mixture-filled container according to any one of [1] to [6].

### REFERENCE SIGNS LIST

A: corrosion resistance test device
1: sulfur dioxide mixed gas raw material
2: flow rate adjuster
3: storage container
4: water meter
10: sealed container
10a: inner surface
11: cylindrical body portion
12: bottom
13: gas discharge portion
14: shoulder portion
20: sulfur dioxide mixture
100: sulfur dioxide mixture-filled container

1. A sulfur dioxide mixture-filled container comprising:
a sealed container made of a metal; and
a sulfur dioxide mixture that is filled in the sealed container and contains at least sulfur dioxide and water in a vapor phase,
wherein the sealed container includes a cylindrical body portion, and
a maximum height of a surface roughness of an inner surface of the cylindrical body portion is 38 μm or less.

2. The sulfur dioxide mixture-filled container according to claim 1,
wherein the maximum height of the surface roughness of the inner surface of the cylindrical body portion is 23 μm or less.

3. The sulfur dioxide mixture-filled container according to claim 2,
wherein the maximum height of the surface roughness of the inner surface of the cylindrical body portion is 6 μm or less.

4. The sulfur dioxide mixture-filled container according to claim 1,
wherein a concentration of the water in the sulfur dioxide mixture is 1000 mol ppm or less.

5. The sulfur dioxide mixture-filled container according to claim 1,
wherein the metal constituting the sealed container includes an alloy steel.

6. The sulfur dioxide mixture-filled container according to claim 5,
wherein the alloy steel is manganese steel or chromium molybdenum steel.

7. A sulfur dioxide composition obtained by being extracted from the sulfur dioxide mixture-filled container according to claim 1.
